(19) United States
(12) Patent Application Publication
(10) Pub. No.: US 2020/0111584 A1
(43) Pub. Date: Apr. 9, 2020

(54) COMPOSITE FUEL WITH ENHANCED OXIDATION RESISTANCE

(71) Applicant: WESTINGHOUSE ELECTRIC COMPANY LLC, Cranberry Township, PA (US)

(72) Inventors: EDWARD J. LAHODA, EDGEWOOD, PA (US); HEMANT SHAH, COLUMBIA, SC (US); PENG XU, COLUMBIA, SC (US); LU CAI, COLUMBIA, SC (US)

(73) Assignee: WESTINGHOUSE ELECTRIC COMPANY LLC, CRANBERRY TOWNSHIP, PA (US)

(21) Appl. No.: 16/697,499

(22) Filed: Nov. 27, 2019

Related U.S. Application Data
(62) Division of application No. 15/695,323, filed on Sep. 5, 2017.

(51) Int. Cl. G21C 21/02; G21C 3/62

(52) U.S. Cl. CPC G21C 21/02; G21C 3/623; G21C 3/045; G21C 3/626; G21C 3/62

(57) ABSTRACT

An improved nuclear fuel that has enhanced oxidation resistance and a process for making it are disclosed. The fuel comprises a composite of U235 enriched U₃Si₂ particles and an amount less than 30% by weight of UO₂ particles positioned along the surface of the U₃Si₂ particles. The composite may be compressed into a pellet form. The process comprises forming a layer of UO₂ on the surface of U₃Si₂ particles, either by exposing U₃Si₂ particles to an atmosphere of up to 15% oxygen by volume dispersed in an inert gas for a period of time and at a temperature sufficient to form UO₂ at the U₃Si₂ particle surface, or by mixing U₃Si₂ particles with an amount up to 30% by weight of UO₂ particles.

### CROSS REFERENCE TO RELATED APPLICATIONS

This application is a division of, and claims priority from, U.S. patent application Ser. No. 15/695,323, filed Sep. 5, 2017.

### STATEMENT REGARDING GOVERNMENT RIGHTS

This invention was made with government support under Contract No. DE-NE0008222 awarded by the Department of Energy. The U.S. Government has certain rights in this invention.

### BACKGROUND OF THE INVENTION

### 1. Field of the Invention

The invention relates to methods for improving water corrosion resistance of triuranium disilicide light water reactor fuel.

### 2. Description of the Prior Art

Nuclear reactors are powered by fuel containing fissile material, traditionally uranium dioxide (UO₂) derived from uranium hexafluoride (UF₆) enriched with the isotope uranium-235 (U235). Because the fission process releases high levels of energy in the form of heat, the fuel must be in a form that can withstand both the high operating temperatures and the neutron radiation environment. Fuel is typically in the form of a stack of pellets clad and sealed in a tube made of a material, such as a zirconium alloy, that can contain the radiation. Conventional fuel pellets are typically fabricated by compressing suitable powders into a generally cylindrical mold. The compressed material is sintered, which results in a substantial reduction in volume.

Conventional fuel pellets can include a maximum of about 5% by weight of U235 (the current licensed limit for many nuclear fabrication facilities) with the remainder of the uranium component composed of one or more other isotopes, typically uranium-238 (U238) with or without trace amounts of other uranium isotopes.

A higher loading of U235 in the uranium fuel composition as well as a higher thermal conductivity would be economically beneficial owing to higher thermal conductivity and longer fuel cycles (currently about 10 to 24 months). To that end, triuranium disilicide (U₃Si₂) has been advanced as at least a partial replacement for UO₂ as the fuel component. U235 constitutes from about 0.7% to about 5% by weight based on the total weight of the uranium component of U₃Si₂. See for example, U.S. Pat. No. 8,293,151 and published application US 2012/0002777, each incorporated herein by reference, wherein fuel compositions having from 50 to 100% U₃Si₂ and zero up to 50% UO₂ are disclosed. In general, the density of U₃Si₂ is greater than the density of UO₂. The density of U₃Si₂ is 12.2 grams/cm³ and the density of UO₂ is 10.96 grams/cm³. U.S. Pat. No. 8,293,151 posits (without intending to be bound by any particular theory), that the increase in density results in improved nuclear plant performance by enabling longer fuel cycles and/or higher power ratings, and that the use of U₃Si₂ in a nuclear fuel composition can allow the U235 content in a nuclear fuel assembly to increase by about 17% percent by weight with an increase in thermal conductivity of between 3 and 5 times, as compared to that obtained with the use of UO₂.

It has been found that U₃Si₂ has good water corrosion resistance at 300° C. similar to UO₂. However, tests indicated that as water temperatures increase, the grain boundaries of U₃Si₂ were preferentially attacked by water and steam, especially at 360° C. and above.

It has been found that U₃Si₂ suffers from excess oxidation at temperatures higher than 360° C. and will completely oxidize in steam at 450° C. and above in a short period of time. The rapid oxidation could present economic problems for a plant in the event of a leak or significant safety problems in the event of a design basis accident, such as a loss of coolant accident or a reactor initiated accident. Oxidation of U₃Si₂ is a potential safety concern in the implementation of U₃Si₂ fuel in light water reactors, including pressurized water reactors and boiling water reactors.

If the benefits of U₃Si₂ as a nuclear fuel are to be realized, the risk of excess oxidation needs to be minimized.

### SUMMARY OF THE INVENTION

The following summary is provided to facilitate an understanding of some of the innovative features unique to the embodiments disclosed and is not intended to be a full description. A full appreciation of the various aspects of the embodiments can be gained by taking the entire specification, claims, and abstract as a whole.

To address the concerns in use of U₃Si₂ as a nuclear fuel, various embodiments of a new more robust fuel designed to enhance oxidation resistance of U₃Si₂ are disclosed herein. Additionally, a process for forming the various embodiments of the more robust fuel with enhanced oxidation resistance is disclosed.

The improved fuel comprises a composite of U235 enriched U₃Si₂ and an amount less than 30% by weight of UO₂. The UO₂ particles may also be enriched with U235 isotopes.

In various aspects, the UO₂ may be in the form of a layer of UO₂ particles on the surface of a U₃Si₂ pellet. Alternatively or additionally, the improved nuclear fuel may be in the form of a pellet formed from compressed U235 enriched U₃Si₂ particles and less than 30% by weight U235 enriched UO₂ particles, wherein the UO₂ particles are predominantly positioned along the grain boundaries of the U₃Si₂ particles.

A method is provided for conditioning U₃Si₂ powder and adding UO₂ as secondary phases to U₃Si₂ in the powder form before consolidation to pellets to improve its water corrosion resistance in coolant during operation and in high temperature steam in loss of coolant accident conditions. To improve the water corrosion resistance of U₃Si₂ at temperatures higher than 360° C., the as fabricated U₃Si₂ powder can be exposed to inert gas atmosphere with a relatively low oxygen partial pressure, such as an amount up to 15% oxygen by volume. Alternatively, UO₂ powder can be added to U₃Si₂ powder in a weight percentage of up to 30% to be consolidated as an U₃Si₂—UO₂ composite.

Also disclosed herein is a process for improving water corrosion resistance of nuclear fuel comprising forming a layer of UO₂ on the surface of U₃Si₂ particles. In certain aspects, the process for forming the UO₂ layer comprises exposing U₃Si₂ particles to an atmosphere of up to 15% oxygen by volume dispersed in an inert gas for a period of time and at a temperature sufficient to form UO₂ at the U₃Si₂ particle surface.

Exposing the U₃Si₂ particles to the gaseous atmosphere may in various aspects include flowing the inert gas and oxygen through or over the particles. Alternatively, exposing the U₃Si₂ particles to the gaseous atmosphere may in various aspects include combining the U₃Si₂ particles and the oxygen-inert gas atmosphere in a mixer and mixing at a rate sufficiently slow to avoid raising the temperature of the particles above 200° C.

In certain aspects, the process for forming the UO₂ layer comprises mixing U₃Si₂ particles with an amount up to 30% by weight of UO₂ particles. Thereafter, the mixed particles are pressed into a pellet and the pellet is sintered. In various aspects, the amount of UO₂ particles mixed with the U₃Si₂ particles is sufficient to adhere the layer of UO₂ particles on the grain boundaries of the U₃Si₂ particles.

In certain aspects, the process for forming the UO₂ layer comprises layering UO₂ particles over a U₃Si₂ pellet either before or after the U₃Si₂ pellet has been sintered. The U₃Si₂ pellet with the UO₂ layer may be sintered. In various aspects, the UO₂ particles form at the grain boundaries of the U₃Si₂ particles at the surface of the pellet.

It is believed that the placement of UO₂ particles at the grain boundaries of the U₃Si₂ particles will slow down the oxidation of U₃Si₂, especially at higher steam temperatures.

### DESCRIPTION OF THE PREFERRED EMBODIMENTS

As used herein, the singular form of “a”, “an”, and “the” include the plural references unless the context clearly dictates otherwise. Thus, the articles “a” and “an” are used herein to refer to one or to more than one (i.e., to at least one) of the grammatical object of the article. By way of example, “an element” means one element or more than one element.

Directional phrases used herein, such as, for example and without limitation, top, bottom, left, right, lower, upper, front, back, and variations thereof, shall relate to the orientation of the elements shown in the accompanying drawing and are not, limiting upon the claims unless otherwise expressly stated.

In the present application, including the claims, other than where otherwise indicated, all numbers expressing quantities, values or characteristics are to be understood as being modified in all instances by the term “about.” Thus, numbers may be read as if preceded by the word “about” even though the term “about” may not expressly appear with the number. Accordingly, unless indicated to the contrary, any numerical parameters set forth in the following description may vary depending on the desired properties one seeks to obtain in the compositions and methods according to the present disclosure. At the very least, and not as an attempt to limit the application of the doctrine of equivalents to the scope of the claims, each numerical parameter described in the present description should at least be construed in light of the number of reported significant digits and by applying ordinary rounding techniques.

Further, any numerical range recited herein is intended to include all sub-ranges subsumed therein. For example, a range of “1 to 10” is intended to include any and all sub-ranges between (and including) the recited minimum value of 1 and the recited maximum value of 10, that is, having a minimum value equal to or greater than 1 and a maximum value of equal to or less than 10.

As used herein, an “inert gas” is a gas which does not undergo chemical reactions under a set of given conditions, such as for example, oxidation reactions. The noble gases often do not react with many substances. Inert gases are used generally to avoid unwanted chemical reactions that would degrade a sample. Purified argon and nitrogen gases are most commonly used as inert gases due to their high natural abundance (78% N₂, 1% Ar in air) and low relative cost. An inert gas is a non-reactive gas under particular conditions. For example, nitrogen at ordinary temperatures and the noble gases (helium, argon, krypton, xenon and radon) are unreactive toward most species and in various aspects may be used as the inert gas in various embodiments of the process disclosed herein.

As used herein, the “grain boundary” is the interface or juncture between adjacent grains in a multi-particulate material. The grain boundary is a transition region in which some atoms are not exactly aligned with either grain. Grain boundaries of particles have less density on the atomic scale, a property that implies the presence of atomic holes, into which atoms can diffuse. This makes the zone at the grain boundaries of U₃Si₂ particles, for example, prone to oxidation, but also available for direct interaction with UO₂ particles or with oxygen to form UO₂ at the grain boundaries. It is believed, without intending to be bound by any particular theory, that when UO₂ particles are positioned along the grain boundaries of the U₃Si₂ particles, the higher oxidation resistance of the UO₂ particles shields the U₃Si₂ particles from oxidation.

As used herein, the term “pre-pelletized” means the particles or powder have previously been compressed into the shape of a pellet and may or may not have been sintered thereafter. Pre-pelletization may be done by any suitable known technique for making pellets and when also sintered, by any suitable known technique for sintering pellets.

To minimize, and preferably significantly reduce and delay, if not eliminate, the risk of oxidation of U₃Si₂ fuel, the corrosion resistance of U₃Si₂ can be improved. There are several solutions for corrosion resistance improvement for U₃Si₂. One solution is to condition U₃Si₂ by exposing it to a mixture of inert gas and oxygen to form UO₂ on the surface of U₃Si₂. An alternative solution is to add UO₂ to U₃Si₂ powder before pressing the green pellets and sintering. The method described herein improves water corrosion resistance of U₃Si₂ by adding an amount of UO₂ to loose or pre-pelletized particles of U₃Si₂, sufficient to form a layer around the grain boundaries of U₃Si₂ particles. The UO₂ may be added to U₃Si₂ either directly or by reaction with oxygen to form UO₂. The UO₂ layer may form around a plurality of U₃Si₂ particles, dispersed throughout the particles. Alternatively, the UO₂ layer may be formed around the grain boundaries of U₃Si₂ particles on the outer surface of a U₃Si₂ pellet.

The improved fuel may, in various aspects comprise a composite of U235 enriched U₃Si₂ particles and an amount less than 30%® by weight of UO₂, which may or may not also be U235 enriched. The UO₂ may be in the form of a layer of particles coating the surface of pre-pelletized U₃Si₂. The UO₂ may be in the form of particles interspersed throughout U₃Si₂ particles. The UO₂ may be in the form of a layer of particles coating the surface of pre-pelletized U₃Si₂ and as particles interspersed throughout U₃Si₂ particles. In each embodiment, the UO₂ particles are positioned along the surface of the U₃Si₂ particles in either a continuous or a discontinuous layer. Some gaps where there is no UO₂ on the surface of some of the U₃Si₂ particles or where only part of the U₃Si₂ particles surface is coated will in practice likely occur resulting in a discontinuous layer.

The improved nuclear fuel may, in various aspects, be in the form of a pellet formed from compressed U235 enriched U₃Si₂ particles and less than 30% by weight UO₂ particles, wherein the UO₂ particles are predominantly positioned along the grain boundaries of the U₃Si₂ particles or the U₃Si₂ pellet. The UO₂ particles may also be U235 enriched, provided the combined U235 enrichment is within the limits of the license granted by the controlling regulatory authority.

Triuranium disilicide (U₃Si₂) may include various uranium isotopes, such as, but not limited to, uranium-238, uranium-236, uranium-235, uranium-234, uranium-233, uranium-232, and mixtures thereof. In certain aspects, the uranium component of the U₃Si₂ substantially includes uranium-238 and uranium-235, and optionally, trace amounts of uranium-236 and uranium-232. In other aspects, the uranium component of the U₃Si₂ includes uranium-235 in an amount such that it constitutes from about 0.7% to about 7% by weight, and typically about 5% by weight, based on the total weight of the uranium component of the U₃Si₂.

In certain aspects, the percentage of uranium-235 in the U₃Si₂ is at the maximum licensed amount, such as from about 4.95% to about 5.00%.

UO₂ has better corrosion resistance than U₃Si₂ and the UO₂ phase in U₃Si₂ is expected to reduce the oxidation of U₃Si₂ and thus improve safety margins for events from fuel leaker events to design basis accidents, such as loss of coolant accidents and reactor initiated accidents.

U₃Si₂ has a higher uranium loading than UO₂, so it is economically more attractive.

Licenses issued by the Nuclear Regulatory Commission (NRC) typically limit fuels for light water reactors to no more than 5%© but in the future may reach 7% U235 of uranium. Therefore, it is advantageous to get as high a density as possible within the allowable limit. In addition, U₃Si₂ has a much higher thermal conductivity than UO₂, (about 5-10 times as high) so the use of U₃Si₂ as the fuel leads to lower operating temperatures and lower fission gas release during operation.

In the composite disclosed herein, the amount of UO₂ should be as minimal as possible because the more UO₂ added, the lower uranium loading or the density of U235 in the fuel. For example, U₃Si₂ has a density of 12.2 glee whereas UO₂ has a density of 10.96 g/cc. The precise amount of UO₂ to add to U₃Si₂ to form the U₃Si₂—UO₂ composite may vary, up to 30% by weight, but, in various aspects, UO₂ may be added in the smallest amount one can while still getting the oxidation resistance that UO₂ provides but avoiding lowering the density of U235 as little as possible.

The improved composite U₃Si₂—UO₂ fuel can be made, for example, by forming a layer of UO₂ on the surface of U235 enriched U₃Si₂. The layer of UO₂ may be formed by exposing the U₃Si₂ particles to an amount of oxygen, up to 15% by volume, dispersed in an inert gaseous atmosphere. In various aspects, the method may proceed by flowing oxygen in an inert gaseous atmosphere over a plurality of U₃Si₂ particles or through a plurality of U₃Si₂ particles, or both at a temperature sufficient to form UO₂. The temperature in various aspects is less than 300° C. The exposure of U₃Si₂ to the oxygen may last for a sufficient time period to allow the reaction forming UO₂ at the grain boundaries of U₃Si₂ to occur. For example, the flow of oxygen in the inert atmosphere may continue for up to several minutes.

The oxygen will react with the U₃Si₂ to form UO₂ on the surface of the U₃Si₂ particles in a reaction that is believed to proceed generally as follows:

Excess U₃Si₂+O₂→UO₂+2USi+unreacted U₃Si₂.
inert gas
   The USi is more stable in oxygen than the original U₃Si₂, but may oxidize further to UO₂ and SiO₂ at much higher temperatures. The inert gas does not participate in the reaction except to absorb and carry away heat. The inert gas may be selected from the group consisting of nitrogen, helium, argon, krypton, xenon and radon. Argon and nitrogen are preferred due to their natural abundance and relative low cost. There should be no hydrogen in the gas. The oxygen is present in an amount up to 15% by volume to prevent a runaway reaction by the U₃Si₂. A runaway reaction will occur if the heat generated by the exothermic reaction of U₃Si₂ with 02 exceeds the cooling due to the heat capacity of the inert gas components and the mass of the U₃Si₂.

The oxygen may be present in an amount ranging from less than one percent up to 15 percent by volume. In various aspects the oxygen is present in an amount greater than zero and less than one percent by volume.

In various aspects, the method may proceed by combining the 0235 enriched U₃Si₂ particles and the atmosphere of up to 15% oxygen and inert gas in a mixer, such as a ribbon mixer, and mixing at a rate sufficiently slow to avoid raising the temperature of the particles above 200° C.

The powder would be mixed by mixing warm U₃Si₂ particles at less than 200° C. with a cool gas mixture, preferably less than 100° C., Mixing is preferably done slowly to avoid heat from the friction created by mixing. The heating can be controlled by changing the rate of mixing. The gas may be injected into the particles as they are mixing. The temperature should be high enough so that the reaction of the 02 and U₃Si₂ occurs to form UO₂ at the boundaries of U₃Si₂, but not so high that oxidation occurs anywhere beyond the edges of the U₃Si₂ particles. The temperature may therefore be monitored with a sensor and adjusted when necessary during mixing to maintain the particles, or powder, at no more than 200° C. As the temperature approaches 200° C., the rate of mixing can be reduced to maintain the temperature below 200° C. A UO₂ surface layer is thereby formed on the U₃Si₂ particles.

In certain aspects, the atmosphere of up to 15% oxygen and inert gas may flow over the surface of pre-pelletized U235 enriched U₃Si₂. The oxygen will react with U₃Si₂ to form UO₂ along the grain boundaries of the U₃Si₂ particles at the outer surface of the pellet, thereby forming a layer of UO₂ around the outer surface of the U235 enriched U₃Si₂ pellet.

In various aspects, the UO₂ particles, in various aspects, U 235 enriched UO₂ particles, may be layered on to pre-pelletized U 235 enriched U₃Si₂, to cover the outer surface of the U₃Si₂ pellet and form a layer of UO₂ at the grain boundaries of the outermost U₃Si₂ particles on the already formed pellet.

Layering the UO₂ particles onto the pellet may be performed by any suitable layering technique, such as cold or hot spray, physical deposition or similar coating process.

In an alternative method, U 235 enriched U₃Si₂ particles may be mixed directly with up to 30% by weight UO₂ particles. In various aspects, the U 235 enriched U₃Si₂ particles may be mixed directly with up to 30% by weight U235 enriched UO₂ particles. The mixing may occur in any suitable mixer, such as, by way of example, commercially available double cone blenders, Turbula® blenders, V-blenders or Nauta® mixers. The rate of mixing should be slow enough to avoid raising the temperature of the particles above 200° C. The mixer therefore may be equipped with a temperature sensor.

The UO₂ size particle distribution in various aspects will be less than the U₃Si₂ particle size distribution by a factor of about less than 10. The UO₂ particles may be likened to dust on a layer of U₃Si₂ particles. The higher the number of particles of UO₂ (on a number basis as opposed to a weight % basis) there are to coat the surface of the U₃Si₂ particles, the more likely it will be that the U₃Si₂ particles are covered, and thereby shielded from oxidation.

After mixing the U₃Si₂ and the UO₂ particles, the U₃Si₂—UO₂ composite may be formed into a pellet by the conventional methods for forming nuclear fuel pellets, and sintered.

For example, in certain aspects, the combined particles may first be homogenized to ensure relative uniformity in terms of particle size distribution and surface area. As stated, the size distribution of the U₃Si₂ particles will be greater than that of the UO₂ particles. In certain aspects, additives, such as lubricants, burnable absorbers and pore-forming agents may be added. The particles may be formed into pellets by compressing the mixture of particles in suitable commercially available mechanical or hydraulic presses to achieve the desired “green” density and strength.

A basic press may incorporate a die platen with single action capability while the most complex styles have multiple moving platens to form “multi-level” parts. Presses are available in a wide range of tonnage capability. The tonnage required to press powder into the desired compact pellet shape is determined by multiplying the projected surface area, of the part by a load factor determined by the compressibility characteristics of the powder.

To begin the process, the mixture of particles is filled into a die. The rate of die filling is based largely on the flowability of the particles.

Once the die is filled, a punch moves towards the particles. The punch applies pressure to the particles, compacting them to the geometry of the die. In certain pelletizing processes, the particles may be fed into a die and pressed biaxially into cylindrical pellets using a load of several hundred MPa.

Following compression, the pellets are sintered by heating in a furnace at about 1750° C. under a controlled reducing atmosphere, usually comprised of argon. Sintering is a thermal process that consolidates the green pellets by converting the mechanical bonds of the particles formed during compression into stronger bonds and greatly strengthened pellets. The compressed and sintered pellets are then cooled and machined to the desired dimensions. Exemplary pellets may be about one centimeter, or slightly less, in diameter, and one centimeter, or slightly more, in length.

The nuclear fuel composition of the present invention can be in various forms, and are not limited to cylindrical pellets. The pellets are typically vertically stacked in a zirconium alloy tube, or cladding, and several such fuel rods form the fuel assembly of a light water reactor.

The present invention has been described in accordance with several examples, which are intended to be illustrative in all aspects rather than restrictive. Thus, the present invention is capable of many variations in detailed implementation, which may be derived from the description contained herein by a person of ordinary skill in the art.

All patents, patent applications, publications, or other disclosure material mentioned herein, are hereby incorporated by reference in their entirety as if each individual reference was expressly incorporated by reference respectively. All references, and any material, or portion thereof, that are said to be incorporated by reference herein are incorporated herein only to the extent that the incorporated material does not conflict with existing definitions, statements, or other disclosure material set forth in this disclosure. As such, and to the extent necessary, the disclosure as set forth herein supersedes any conflicting material incorporated herein by reference and the disclosure expressly set forth in the present application controls.

The present invention has been described with reference to various exemplary and illustrative embodiments. The embodiments described herein are understood as providing illustrative features of varying detail of various embodiments of the disclosed invention; and therefore, unless otherwise specified, it is to be understood that, to the extent possible, one or more features, elements, components, constituents, ingredients, structures, modules, and/or aspects of the disclosed embodiments may be combined, separated, interchanged, and/or rearranged with or relative to one or more other features, elements, components, constituents, ingredients, structures, modules, and/or aspects of the disclosed embodiments without departing from the scope of the disclosed invention. Accordingly, it will be recognized by persons having ordinary skill in the art that various substitutions, modifications or combinations of any of the exemplary embodiments may be made without departing from the scope of the invention. In addition, persons skilled in the art will recognize, or be able to ascertain using no more than routine experimentation, many equivalents to the various embodiments of the invention described herein upon review of this specification. Thus, the invention is not limited by the description of the various embodiments, but rather by the claims.

What is claimed is:

1. A nuclear fuel comprising:
a pellet formed from compressed U235 enriched U₃Si₂ particles and less than 30% by weight UO₂ particles, wherein the UO₂ particles are predominantly positioned along the grain boundaries of the U₃Si₂ particles.

2. The fuel recited in claim 1 wherein the particle size distribution of the UO₂ particles is less than the particle size distribution of the U₃Si₂ particles by a factor of ten and the number of UO₂ particles exceeds the number of U₃Si₂ particles.

3. The fuel recited in claim 1 wherein the UO₂ particles are enriched in U235 and the combined U235 enrichment is up to seven percent by weight.

4. The fuel recited in claim 1 wherein the UO₂ particles are present in an amount greater than zero and less than one percent by weight.

5. A nuclear fuel comprising:
a composite of U235 enriched U₃Si₂ particles and an amount less than 30% by weight of UO₂ particles positioned along the surface of the U₃Si₂ particles.

6. The fuel recited in claim 5 wherein the composite comprises greater than zero and less than one percent by weight of UO₂ particles.

7. The fuel recited in claim 5 wherein the uranium in the UO₂ particles is enriched with U235 and the total U235 enrichment of the composite is no more than seven percent by weight.

8. The fuel recited in claim 5 wherein the composite is compressed into a pellet and sintered.

9. A process for improving water corrosion resistance of nuclear fuel comprising:
applying a layer of up to 30% by weight of UO₂ particles on the surface of U₃Si₂ particles.

10. The process recited in claim 9 wherein the UO₂ layer is applied to pre-pelletized U₃Si₂ particles.

11. The process recited in claim 9 wherein the step of applying the UO₂ particles and the U₃Si₂ particles comprises mixing the UO₂ and the U₃Si₂ particles together while maintaining a temperature less than 200° C.

12. The process recited in claim 11 wherein the UO₂ particles and the U₃Si₂ particles are homogenized for relative uniformity of particle size distribution and surface area.

13. The process recited in claim 11 further comprising pressing the mixture of UO₂ coated U₃Si₂ particles into one or more pellets and sintering the one or more pellets.

14. The process recited in claim 9 wherein the step of applying the UO₂ particles and the U₃Si₂ particles comprises layering the UO₂ particles over a U₃Si₂ pellet.

15. The process recited in claim 14 further comprising sintering the UO₂ layered U₃Si₂ pellet.

16. The process recited in claim 14 wherein the layer of UO₂ particles covers an outer surface of the U₃Si₂ pellet and forms a layer of UO₂ at the grain boundaries of the U₃Si₂ particles positioned on an outermost layer of the U₃Si₂ pellet.

17. The process recited in claim 9 wherein the amount of UO₂ particle is sufficient to adhere the layer of UO₂ particles on the grain boundaries of the U₃Si₂ particles.

18. The process recited in claim 9 wherein the UO₂ layer is discontinuous.

19. The process recited in claim 9 wherein the UO₂ layer is continuous.

20. The process recited in claim 9 wherein the uranium in the U₃Si₂ particles and the UO₂ particles is enriched in U235 up to a combined total of seven percent by weight.

21. The process recited in claim 9 wherein the uranium the U₃Si₂ particles is enriched in U235 up to five percent by weight.

22. The process recited in claim 9 wherein the UO₂ particle size distribution is less than the U₃Si₂ particle size distribution by a factor of less than 10.

23. The process recited in claim 9 wherein the number of UO₂ particles is greater than the number of U₃Si₂ particles.
